(19) United States
(12) Patent Application Publication
(10) Pub. No.: US 2025/0091065 A1
(43) Pub. Date: Mar. 20, 2025

(54) COMPACT DEVICE FOR GENERATING FOAM FOR WELLNESS AND/OR HYGIENE APPLICATIONS

(71) Applicant: Klafs GmbH, Schwäbisch Hall (DE)

(72) Inventor: Markus Gabele, Schwäbisch Hall (DE)

(21) Appl. No.: 18/414,529

(22) Filed: Jan. 17, 2024

(30) Foreign Application Priority Data
Sep. 15, 2023 (EP) 23197699.4

(51) Int. Cl. B05B 7/00

(52) U.S. Cl. CPC B05B 7/0018

(57) ABSTRACT

The device includes a vessel for filling with a mixture of water and a foam-forming component. The vessel comprises a device for injecting air into the foam generation mixture. The device has at least two vessels arranged one above the other in a vertical direction in a leveled form for filling with the mixture and for injecting air into the foam generation mixture. The vessels are open towards an outlet region in such a way. The foam generated in the vessels is merged in the outlet region.

### CROSS-REFERENCE TO RELATED APPLICATION

This Patent Application claims priority to European Patent Application No. 23197699.4, filed on Sep. 15, 2023, and entitled “COMPACT DEVICE FOR GENERATING FOAM FOR WELLNESS AND/OR HYGIENE APPLICATIONS.” The disclosure of the prior Application is considered part of and is incorporated by reference into this Patent Application.

### BACKGROUND

### 1. Field

The present disclosure relates to a device for generating foam for wellness and/or hygiene applications.

Such a device comprises at least two levels arranged one above the other in the vertical direction. The levels have foam generation surfaces with openings and a device for blowing in air and are arranged in such a way that a mixture of water and a foam-forming component can be distributed over the foam generation surfaces and air can be blown into the mixture through the openings of the foam generation surfaces by means of the device for blowing in air to generate foam. The levels are opened to an outlet area in such a way that the foam generated in the levels is combined in the outlet area

### 2. Related Art

A device according to the generic concept is known, for example, from EP 4 115 971 A1. Here, the levels include vessels whose horizontal bases are configured as foam generation surfaces. It is indeed possible to generate a relatively large amount of foam in a relatively small space by means of the aforementioned device. However, further improvement is needed here to achieve a device that is as compact as possible and generates as much foam as possible for wellness and/or hygiene applications.

### SUMMARY

It is the task of the present disclosure to provide such a device.

Accordingly, a solution to the problem according to the disclosure is provided if the foam generation surfaces are inclined with respect to a horizontal plane to the outlet area.

As a result, the important base area can be reduced while the area of the foam generation surfaces remains the same, whereby the applicants have recognized that, on the one hand, the inclined foam generation surfaces improve and simplify the distribution of the mixture and, at the same time, a higher foam volume per area of the foam generation surface can be achieved. Accordingly, a consistent or even higher foam volume can be produced from a smaller overall base area and with a smaller overall volume of the device.

“Air” as used in the present disclosure is intended to mean breathing air as well as any other gas mixture which may be used for foam generation. Preferably, however, breathing air or ambient air is used.

The mixture distributed over the foam generation surfaces preferably contains between 0.2 to 3% foam-forming component. For normal operation, this proportion is preferably 1%, although the proportion may vary depending on the foam generation rate.

Advantageous embodiments of the present disclosure are the subject of the subclaims.

According to a preferred embodiment, the foam generation surfaces have an angle between themselves and the horizontal plane of between 3° and 45°. In this range, a particularly compact device results with improved foam production at the same time. Preferably, the angle is between 5° and 20°, particularly preferably at 10°. This allows the effect achieved by the inclination of the foam generation surfaces to be increased even further.

According to another particularly preferred embodiment, the device has four levels. With four levels arranged one above the other, sufficient foam can be generated for wellness and/or hygiene applications, and the installation space still remains within an acceptable and advantageous range.

In a preferred embodiment, each foam generation surface has an area between 50 and 1500 cm2, preferably between 300 and 900 cm2. Such a total area of the foam generation surfaces allows foam to be generated at an advantageous rate without making the device too bulky.

According to another preferred embodiment, the device has a housing with a foam outlet opening following the outlet area. This allows the generated foam to be selectively discharged from the device for wellness and/or hygiene applications. Preferably, various orifices can be inserted into the housing as an inspection outlet opening. In this way, the method of application can be adapted. Also preferably, the housing has a volume between 6000 and 70000 cm3, particularly preferably between 30000 and 50000 cm3. Such a volume allows an advantageous compromise between foam generation rate and bulkiness of the device.

In a preferred embodiment, the levels each comprise at least one fluid inlet, preferably at least two fluid inlets, more preferably three fluid inlets, arranged above an upper end of the foam generation surface and arranged such, that the mixture from the fluid inlet flows over the foam generation surface. As a result, the mixture can be distributed over the foam generation surface in a relatively simple manner by design. At the same time, the slope of the foam generation surface can be used for distribution and a thin layer of the mixture is obtained over the foam generation surface, which is advantageous for foam generation. Preferably, the device is arranged such, that an introduced mixture flow rate through the liquid inlets is adjustable. This allows the thickness of the layer on the foam generation surfaces to be adjusted and maximizes foam generation.

Advantageously, a reservoir is arranged along the upper end of the foam generation surface, separated from the foam generation surface by a weir, and arranged such, that the at least one liquid inlet fills the reservoir and, when the reservoir is full, the mixture flows over the weir onto the foam generation surface. By using the reservoir in conjunction with the at least one fluid inlet, it is constructively simple to distribute the mixture evenly along the entire length of the weir or reservoir onto the foam generation surface. Preferably, the reservoir and the weir are arranged along the entire upper end of the foam generation surface. Thus, the mixture reaches the foam generation surface via the weir along the entire upper end of the foam generation surface. Accordingly, the entire area of the foam generation surface can be utilized.

In a preferred embodiment, the liquid inlets of the levels are connected to a common water reservoir and foam-generating component reservoir, each having at least one pump arranged to pump water from the water reservoir and foam-generating component from the component reservoir to the liquid inlets. This allows the ratio of foam-forming component to water in the mixture to be precisely adjusted, resulting in an increased foam generation rate. In addition, a special pump can be used that is adapted to the properties of the foam-forming component.

Preferably, the mixture flow rate through the liquid inlets is adjustable by controlling the pumps.

Further preferably, the water reservoir has a volume of 2.5 to 4.5 1, particularly preferably a volume of 3.0 to 4.0 1, and the foam-forming component reservoir has a volume of 0.2 to 1.0 1, particularly preferably a volume of 0.4 to 0.6 1. In this way, sufficient foam generation can be ensured, wherein the device is still designed compact.

Preferably, the water reservoir is designed as a drawer in the housing. This allows the water reservoir to be easily removed and refilled.

In a particularly preferred embodiment, a drain channel is arranged along a lower end of the foam generation surface, which is arranged such, that the mixture which flows over the foam generation surface and from which no foam has been generated is collected and discharged by the drain channel, the drain channel preferably having a slope so that the mixture can flow away. This prevents excess mixture from falling into and wetting or destroying foam generated by lower levels.

Preferably, the drain channel has two slopes that slope downward from a central elevated position in the drain channel to edges of the drain channel. This allows the excess mixture to be efficiently discharged through the drain channel.

Further preferably, the drain chute and the water reservoir are arranged such, that the mixture collected by the drain chute is fed to the water reservoir. This allows the mixture to be recycled. For this embodiment it is crucial, that the at least one pump of the water reservoir is also suitable for use with the mixture.

According to a preferred embodiment, the levels below the foam generation surface comprise a wedge-shaped cavity, which is part of the device for blowing in air and to which at least one fan is connected in such a way, that the at least one fan pumps air into the wedge-shaped cavity, which then exits through the openings of the foam generation surface. This allows the openings of the foam generation surface to be efficiently supplied with air. At the same time, the structure of the device remains compact and there is no need for a complex supply of air to each individual opening.

Preferably, the device for blowing is set up in such a way that a volume flow through the entirety of the openings of the foam generation surfaces of the levels can be set between 10and 500 l/min, preferably between 200 and 400 l/min. At this volume flow, particularly efficient foam generation results.

In a further preferred embodiment, the wedge-shaped cavities of the at least two levels are connected to a common air supply comprising at least one fan, preferably two fans. This allows components to be saved. At the same time, this enables a more compact design of the device.

Preferably, the housing has air inlets through which the at least one fan located in the housing draws air into the common air supply. This allows the fan to be supplied with fresh air. At the same time, the fan is protected from external influences and operation of the device is safer.

According to another embodiment, the device has two centrifugal fans, preferably arranged to the left and right of the levels, with their outlets oriented horizontally and in opposite directions and connected to the wedge-shaped cavities. Due to the high efficiency of the centrifugal fans, the device can be efficiently supplied with air. Furthermore, by locating the centrifugal fans adjacent the levels, the device can be kept compact.

In a preferred embodiment, the openings of the foam generation surface have a cross-sectional area between 0.002 and 0.2 cm2, preferably between 0.006 and 0.15 cm2, and are preferably circular. This cross-sectional area and shape has been proven to be beneficial to the foam generation rate. It has also been shown to result in minimal backflow of mixture into the wedge-shaped cavities.

Preferably, one of the openings of the foam generation surface is present per 0.25 to 2.0 cm2 of the foam generation surface, with the openings being evenly distributed over the foam generation surface. This provides for an improved foam generation rate.

According to a preferred embodiment, the foam generation surface each has a u-shaped member around one of the openings of the foam generation surface, which is open in the direction of the upper end of the foam generation surface and forms a recess around the opening, wherein preferably upwardly directed legs of the u-shaped member steadily decrease in their height relative to the foam generation surface and merge into the foam generation surface. This also leads to an improvement in the foam generation rate.

In another particularly preferred embodiment, the device has a battery that supplies power to the device in such a way that the device can be used in a mobile manner. This allows the compact device to be used independently of a power supply and to be taken into humid environments, such as showers and steam baths.

According to another preferred embodiment, the device has a control system arranged such, that when the device is started, the devices for blowing in air are first started before the mixture is pumped through the liquid inlets to the foam generation surfaces. This can effectively prevent backflow of mixture into the wedge-shaped cavities. Preferably, the amount of air and mixture introduced can be adjusted by the control system. Thus, the foam generation rate can be actively controlled and adapted to the wellness and/or hygiene applications.

Furthermore, the present disclosure relates to a method for generating foam for wellness and/or hygiene applications from a mixture of water and a foam-generating component using a device according to one of the embodiments described above. With this method, a high foam generation rate can be achieved with a very compact device, which is extremely advantageous for many wellness and/or hygiene applications even in limited space.

In a preferred embodiment of the method, the foam generating component is a coconut soap. This allows a high foam generation rate, and, at the same time, is suitable for many wellness and/or hygiene applications and has additional positive effects for the user.

According to another preferred embodiment of the method, in addition to water ice cubes are present in the water reservoir of the corresponding device. Thus, cool foam can be generated, which enables additional wellness and/or hygiene applications.

### BRIEF DESCRIPTION OF THE DRAWINGS

Embodiments of the disclosure are explained in more detail below with reference to drawings.

The figures show:

FIG. 1A, B schematic oblique views from different angles of a first embodiment of the device according to the disclosure,

FIG. 2A a schematic oblique view of a first part of the housing of the first embodiment of the device according to the disclosure,

FIG. 2B a schematic oblique view of a water reservoir in the form of a drawer of the housing of the first embodiment of the device according to the disclosure,

FIG. 2C a schematic oblique view of an orifice of the housing of the first embodiment of the device according to the disclosure,

FIG. 2D a schematic oblique view of a frame of the housing of the first embodiment of the device according to the disclosure,

FIG. 3 a schematic oblique view of the components water reservoir, component reservoir, two centrifugal fans, four foam generation surfaces, an orifice, a battery and rotary knobs of the first embodiment of the device according to the disclosure without the remaining components of the device,

FIG. 4 a schematic oblique view of the components four foam generation surfaces and internal framework of the first part of the housing of the first embodiment of the device according to the disclosure without the remaining components of the device,

FIG. 5 a detailed view of a foam generation surface of the first embodiment of the device according to the disclosure,

FIG. 6 a horizontal sectional view through the first embodiment of the device according to the disclosure,

FIG. 7 a horizontal sectional view through the first part of the housing of the first embodiment of the device according to the disclosure, and

FIG. 8A, B schematic oblique views from different angles of a second embodiment example of the device according to the disclosure without housing, water reservoir, component reservoir and connection of the reservoirs.

### DETAILED DESCRIPTION

For the following embodiments, identical parts are designated by identical reference signs. If a figure contains reference signs that are not discussed in detail in the associated figure description, reference is made to preceding or subsequent figure descriptions.

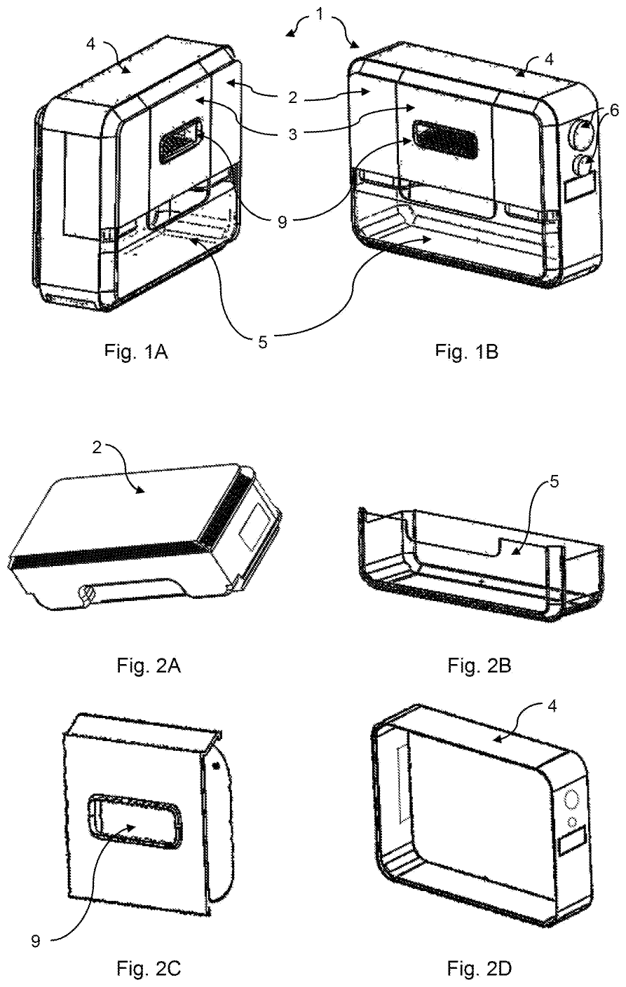

FIG. 1A and B show schematic oblique views from different angles of a first embodiment of a device 1 according to the disclosure. The device 1 has a housing comprising a first part 2 with a foam outlet opening 9 in an orifice 3, a frame 4 and a water reservoir 5 in the form of a drawer which can be inserted into the frame 4 below the first part 2 of the housing. The frame 4 thereby encloses the first part 2 of the housing and the water reservoir 5. Openings for two rotary knobs 6, for a battery 7 and an inlet for a component reservoir 8 are provided in the frame 4.

FIG. 2A shows the first part 2 of the housing with air inlets at the back and an opening for the component reservoir 8. FIG. 2B shows a detailed view of the water reservoir 5 in the form of a drawer, which may be made of transparent plastic and which fits with a bottom side of the first part 2 of the housing. FIG. 2C shows the orifice 3, which has the foam outlet opening 9 and which can be attached to the first part 2 of the housing. FIG. 2D shows the frame 4 that extends around the first part 2 of the housing and the water reservoir 5.

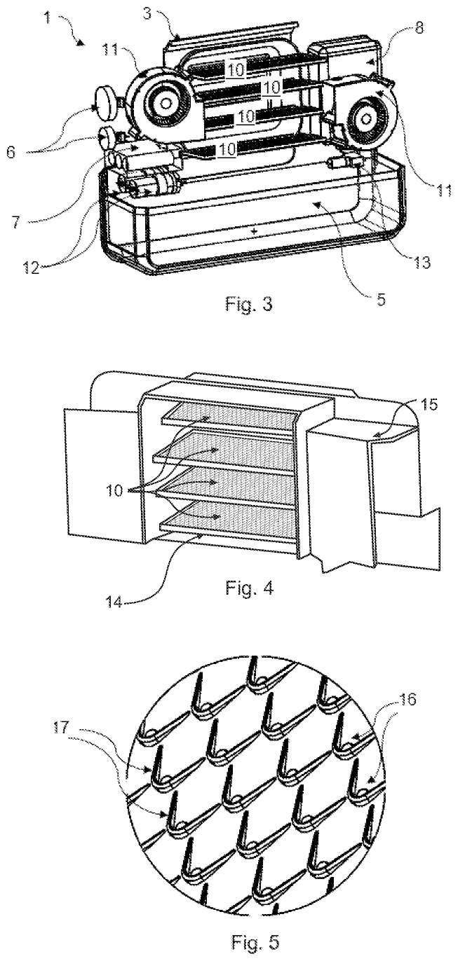

FIG. 3 shows internal components, such as the four foam generating surfaces 10, the component reservoir 8, two centrifugal fans 11, two water pumps 12, a component pump 13 and a battery 7, as well as externally visible components, such as the water reservoir 5, the orifice 3 and the rotary knobs 6, of the first embodiment of the device 1 according to the disclosure. In this respect, the components shown in FIG. 3 are arranged relative to each other as in the device 1 according to the first embodiment. Accordingly, the four foam generation surfaces 10 are arranged one above the other and inclined to the foam outlet opening 9. The component reservoir 8, the battery 7, the two centrifugal fans 11, the water pumps 12 and the component pump 13 are arranged above the water reservoir 5 on the two sides adjacent to the foam generation surfaces 10, so that the internal components can be accommodated in a compact manner in the first part 2 of the housing and the component reservoir 8 and the battery 7 are accessible through the respective opening or inlet in the frame 4.

FIG. 4 shows an internal frame 15, which is arranged in the first part 2 of the housing and to which the internal components are attached, and the four foam generation surfaces 10, the frame 15 forming a space around the foam generation surfaces 10 in which foam is generated and which is delimited from the rest of the internal components. The foam generation surfaces 10 have drain channels 14 along their entire lower end. Further, the foam generation surfaces 10 have openings 16 uniformly distributed over the foam generation surfaces 10 and surrounded by u-shaped elements 17 open towards the upper end of the foam generation surface 10 and forming a recess around the openings 16, upwardly directed legs of the u-shaped elements 17 steadily decreasing in height relative to the foam generation surfaces 10 and merging into the foam generation surface 10. This is particularly evident in the detailed view of a foam generation surface 10 in FIG. 5.

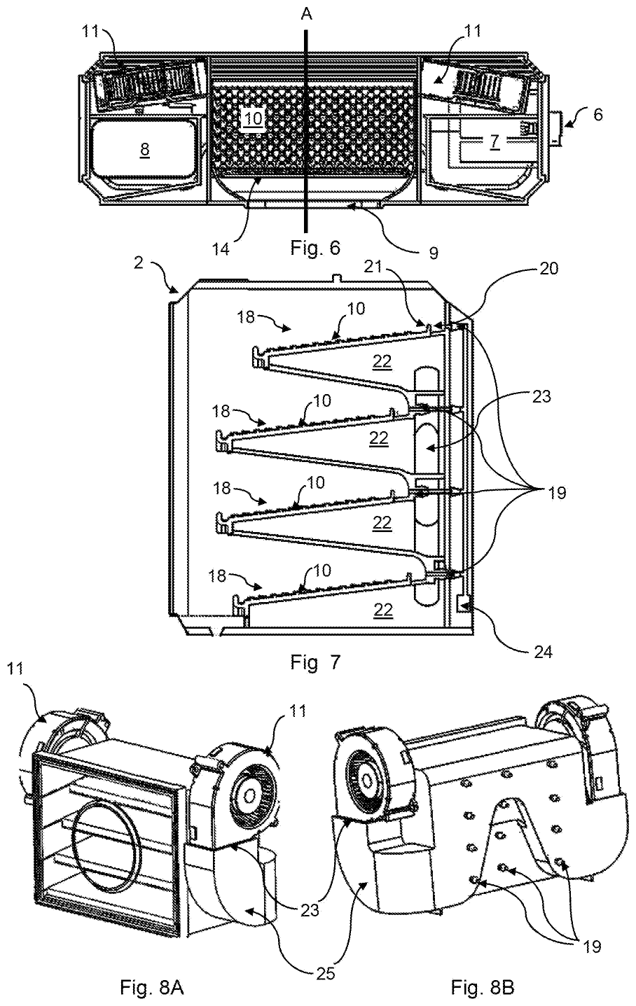

FIG. 6 shows a horizontal sectional view through the first embodiment of the device 1 according to the disclosure. In the view, a foam generation surface 10 can be seen, whereby at the lower end of which a drain channel 14 is arranged. Adjacent to the drain channel 14 there is the outlet area and then the foam outlet opening 9. Furthermore, the two centrifugal fans 11 can be seen, each arranged on one side adjacent to the foam generation surface 10 and oriented to draw air through the air inlets at the rear of the first part 2 of the housing and blow it into a cavity behind the foam generation surface 10. Also adjacent to the foam generation surface 10 there is the component reservoir 8 on one side in front of the centrifugal fan 11, and the battery 7 on the other side below the centrifugal fan 11.

FIG. 7 shows a vertical sectional view through the first part 2 of the housing, wherein the sectional axis A is drawn into FIG. 6. In the sectional view, the four levels 18 can be seen with their respective foam generation surfaces 10. Each level 18 has a fluid inlet 19 arranged above an upper end of the respective foam generation surface 10 and arranged such, that the mixture from the fluid inlet 10 flows over the foam generation surface. In this regard, each level 18 has a reservoir 20 along the upper end of the foam generation surface 10, which is separated from the foam generation surface 10 by a weir 21 and arranged such, that the fluid inlet 19 fills the reservoir 20 and, when the reservoir 20 is full, the mixture flows over the weir 21 onto the foam generation surface 10. The fluid inlets 19 of the levels 18 are connected to the water pumps 12 and the component pump 13 via a hose system 24. Accordingly, the water pumps 12 can supply water from the water reservoir 6 and the component pump 13 can supply foam generating component from the component reservoir 8 to the respective level 18 via the hose system 24 and the respective fluid inlet 19. The respectively supplied mixture of water and foam generating component then flows over the foam generation surfaces 10 of the respective levels 18 via the weir 21.

The respective levels 18 have wedge-shaped cavities 22 below the foam generation surfaces 10, which ultimately form a common cavity connected to a respective fan opening 23 of the two centrifugal fans 11. Now, when the centrifugal fans 11 pump air into the common cavity and thus into the wedge-shaped cavities 22, wherein this air exits through the openings 16 in the foam generation surfaces 10 and forms foam bubbles in the mixture of water and foam-forming component flowing over the foam generation surfaces 10. These foam bubbles then move toward the outlet area and eventually exit the device 1 through the foam outlet opening 9. The foam thus generated can then be used for wellness and/or hygiene applications. Since, in some cases, not all of the mixture of water and foam-generating component flowing over the foam generation surfaces 10 is converted into foam, this mixture is collected at the lower end of the foam generation surfaces 10 in the drain channels 14, and from there is directed into the water reservoir 5. The way the mixture is directed from the ends of the drain trough 14 into the water reservoir 5 is not shown in the figures. A catch basin is located between the drain channel 14 of the foam generation surface 10 of the lowest level 18 and the foam outlet opening 9, in which additional mixture that settles from the generated foam is collected, which is then directed into the water reservoir.

The amount and constitution of foam produced can be adjusted by means of rotary knobs 6, which can be used to control the air supply from the centrifugal fans 11 and the mixture supply from the water pumps 12 and component pump 13.

FIGS. 8A and 8B show schematic oblique views from various angles of a second embodiment of the device I according to the disclosure without the housing, water reservoir, component reservoir and connection of the reservoirs. In contrast to the first embodiment example, the centrifugal fans 11 are rotated by 90° and the fan openings 23 each point downward. In order to connect the wedge-shaped cavities 22 of the levels 18 to the centrifugal fans 11, the second embodiment of the device 1 according to the disclosure has two air ducts 25 connected to the fan openings 22 and connecting them to the wedge-shaped cavities 22 of the levels 18. Another difference between the second embodiment example and the first embodiment example is that the foam generation surfaces 10 do not have U-shaped elements 17, but only openings 16, which are not shown in FIG. 8A. Further, the device 1 according to the second embodiment example has three fluid inlets 19 per level 18, respectively.

Obviously, many modifications and variations of the present disclosure are possible in light of the above teachings and may be practiced otherwise than as specifically described while within the scope of the appended claims. Additionally, it is to be understood that all features of all claims and all embodiments can be combined with each other as long as they do not contradict each other.

### REFERENCE SIGNS

1 device
2 first part
3 orifice
4 frame
5 water reservoir
6 rotary knobs
7 battery
8 component reservoir
9 foam outlet opening
10 foam generation surface
11 centrifugal fans
12 water pump
13 component pump
14 drain channel
15 frame
16 openings
17 u-shaped element
18 level
19 liquid inlet
20 reservoir
21 weir
22 wedge-shaped cavity
23 fan opening
24 hose system
25 air duct

What is claimed is:

1. A device for generating foam for wellness and/or hygiene applications, the device comprising:
at least two levels arranged one above the other in the vertical direction, the levels having foam generation surfaces with openings and a device for blowing in air, and being arranged in such a way, that a mixture of water and a foam-forming component can be distributed over the foam generation surfaces and air can be blown into the mixture through the openings of the foam generation surfaces by means of the device for blowing in air, to generate foam, wherein the levels are opened to an outlet area in such a way, that the foam generated in the levels is combined in the outlet area, and
wherein the foam generation surfaces are inclined with respect to a horizontal plane in direction to the outlet area.

2. The device according to claim 1, wherein the foam generation surfaces have an angle between themselves and the horizontal plane of between 3° and 45°.

3. The device according to claim 2, wherein the foam generation surfaces have an angle between themselves and the horizontal plane of between 5° and 20°.

4. The device according to claim 1, wherein the levels each comprise at least one liquid inlet, arranged above an upper end of the foam generation surface and arranged such that the mixture from the liquid inlet flows over the foam generation surface.

5. The device according to claim 4, wherein the levels each comprise at least two liquid inlets.

6. The device according to claim 5, wherein the levels each comprise at least three inlets.

7. The device according to claim 6, wherein a reservoir is arranged along the upper end of the foam generating surface, separated from the foam generating surface by a weir and arranged such, that the at least one liquid inlet fills the reservoir and the mixture flows over the weir onto the foam generating surface when the reservoir is full.

8. The device according to claim 4, wherein the liquid inlets of the levels are connected to a common water reservoir and foam-generating component reservoir, each comprising at least one pump arranged to pump water from the water reservoir and foam-generating component from the component reservoir to the liquid inlets.

9. The device according to claim 4, wherein a drain channel is arranged along a lower end of the foam generation surface, which is arranged such that the mixture flowing over the foam generation surface and from which no foam has been generated is collected and discharged by the drain channel, and wherein the drain channel preferably having a slope so that the mixture can flow off.

10. The device according to claim 9, wherein the drain channel and the water reservoir are arranged in such a way, that the mixture collected by the drain channel is supplied to the water reservoir.

11. The device according to claim 1, wherein the levels below the foam generation surface comprise a wedge-shaped cavity, which is part of the device for blowing in air and to which at least one fan is connected in such a way, and wherein the at least one fan pumps air into the wedge-shaped cavity, which then exits through the openings of the foam generation surface.

12. The device according to claim 11, wherein the wedge-shaped cavities of the at least two levels are connected to a common air supply comprising at least one fan, preferably two fans.

13. The device according to claim 1, wherein the openings of the foam generation surface have a cross-sectional area that is between 0.002 and 0.2 cm².

14. The device according to claim 13, wherein the openings of the foam generation surface have a cross-sectional area that is between 0.006 and 0.15 cm².

15. The device according to claim 13, wherein the openings of the foam generation surface are circular.

16. The device according to claim 1, wherein the foam generation surface each comprises a u-shaped element arranged around one of the openings of the foam generation surface, which is open towards the upper end of the foam generation surface and forms a recess around the opening, wherein preferably upwardly directed legs of the u-shaped element continuously decreasing in height relative to the foam generation surface and merging into the foam generation surface.

17. The device according to claim 1, wherein the device comprises a battery which supplies the device with power in such a way, and wherein the device can be used in a mobile manner.

18. A method for generating foam for wellness and/or hygiene applications with a device according to claim 1.

19. The method according to claim 18, wherein the foam-forming component is a coconut soap.

20. The method according to claim 18, wherein the levels each comprise at least one liquid inlet arranged above an upper end of the foam generation surface and arranged such that the mixture from the liquid inlet flows over the foam generation surface,
wherein a reservoir is arranged along the upper end of the foam generating surface, separated from the foam generating surface by a weir and arranged such, that the at least one liquid inlet fills the reservoir and the mixture flows over the weir onto the foam generating surface when the reservoir is full, and
wherein in addition to water, ice cubes are present in the water reservoir of the device.
